(19) United States
(12) Patent Application Publication
(10) Pub. No.: US 2011/0206802 A1
(43) Pub. Date: Aug. 25, 2011

(54) BIODEGRADABLE CHEWING GUM BASES AND USES THEREOF

(76) Inventor: Allison Flynn, Albany, CA (US)

(21) Appl. No.: 13/127,737

(22) PCT Filed: Nov. 3, 2009
(86) PCT No.: PCT/US09/63091

§ 371 Date: May 5, 2011

Related U.S. Application Data
(60) Provisional application No. 61/111,837, filed on Nov. 6, 2008.

(51) Int. Cl. A23G 4/08; A23G 4/18

(52) U.S. Cl. 426/5; 426/3

(57) ABSTRACT

Biodegradable chewing gum bases containing one or more crosslinked polyesters, and methods of making and using thereof are described herein. In one embodiment, the base contains a first monomer derived from a saturated or unsaturated lipid, such as a saturated or unsaturated hydroxy fatty acid, optionally a second monomer derived from a saturated or unsaturated polyol, such as a saturated or unsaturated polycarboxylic acid or polyhydroxy compound, and optionally a third monomer, such as a saturated or unsaturated monocarboxylic acid, polycarboxylic and/or hydroxy acid having 5 carbons or less. The polyesters can be crosslinked in the presence of a free radical initiator via thermally-initiated or photo-initiated free radical polymerization. The chewing gum bases are rubbery at room temperature, have a low degree of tackiness and have low glass transition temperatures. One or more additive can be incorporated and/or active agents can also be incorporated into the chewing gum base.

### FIELD OF THE INVENTION

This invention is in the field of chewing gum bases, particularly biodegradable chewing gum bases.

### BACKGROUND OF THE INVENTION

Chewing gum generally contains a gum base and various additives, including plasticizers, sweeteners, emulsifiers, flavoring agents, and coloring agents. Typical gum bases are prepared from elastomeric thermosets of butadiene, isoprene, butadiene-styrene, or other conjugated dienes, which closely resemble the natural latex rubbers that were originally used as chewing gum bases. These gum bases, however, are not biodegradable due to the lack of biodegradable bonds or linkages in the polymers.

The use of biodegradable polymers to prepare chewing gum bases has been previously investigated. U.S. Pat. Nos. 5,672,367 to Grijpma et al. and 7,247,326 to Sodergard describe linear and branched polylactic acid (PLA) and polyhydroxy butyrate (PHB) polymers for use as chewing gum bases. However, the cost of the cyclic monomers needed to prepare the polymers on a commercial scale may be cost prohibitive. Further, the polymers described in Grijpma and Sodergard have a glass transition temperature (T_{g}) of 60° C. or greater, which is significantly higher than the industry standard of 37° C. (i.e., body temperature). As a result, gum bases and chewing gums prepared from these polymers require excess plasticizer(s) to impart the desired flexibility. Also, once the plasticizer(s) are ingested, the base again becomes hard and brittle, which is undesirable for chewing gum.

U.S. Pat. Nos. 6,441,126 to Cook et al; 6,444,782 to Hamlin; and 6,592,913 to Cook et al. and U.S. Patent Application Publication No. 2007/0043200 to Yamamoto et al. describe biodegradable gum bases prepared from highly branched polyesters. However, the architecture of these materials can vary widely depending on the ratio of alcohol to acid used to prepare the polymers as well as the concentration of linear components in the system, making manufacture of consistent product problematic. Further, there is evidence that the branched polyesters have short degradation times, for example, while the consumer is chewing the gum, resulting in an unpleasant sensation in the mouth.

There exists a need for improved biodegradable chewing gum bases having glass transition temperatures near body temperature to minimize the need for excess amounts of plasticizer and which do not degrade in the mouth.

It is an object of the invention to provide biodegradable chewing gum bases having glass transition temperatures close to body temperature and which do not degrade in the mouth of the user, and methods of making and using thereof.

### SUMMARY OF THE INVENTION

Biodegradable chewing gum bases containing one or more crosslinked polyesters, and methods of making and using thereof are described herein. In one embodiment, the base contains a first monomer derived from a saturated or unsaturated lipid, such as a saturated or unsaturated hydroxy fatty acid or mono-, di-, or triglyceride, optionally a second monomer derived from one or more saturated or unsaturated polyols or oligo- or polyethers or polyesters, and optionally a third monomer, such as a saturated or unsaturated monocarboxylic acid, polycarboxylic and/or hydroxy acid having 5 carbons or less. The resulting polyester can be further crosslinked via a free radical process as described below. In another embodiment, the base contains an unsaturated lipid that has epoxidized side groups that can be activated in a secondary crosslinking step.

In another embodiment, the base contains a diol or triol combined with an unsaturated di or other multifunctional hydroxyacid, wherein the resulting polyester can be crosslinked in the presence of a free radical initiator via thermally-initiated or photo-initiated free radical polymerization.

In another embodiment, the polymer can be crosslinked in the presence of one or more unsaturated polycarboxylic acids, such as fumeric acid. The addition of unsaturated dicarboxyclic acids can be used to control the tackiness and/or crosslink density of the base.

The chewing gum bases are rubbery at room temperature, have a low degree of tackiness as measured by the “probe tack” testing method, and have low glass transition temperatures, for examples from about −20° C. to about 35° C., preferably from about 0° C. to about 30° C. One or more additives can be incorporated into the gum base.

Suitable additives include, but are not limited to, emulsifiers, gum base solvents, fillers, antioxidants, plasticizers, sweeteners, flavoring agents, coloring agents, and combinations thereof. The concentration of plasticizers and/or softeners is from about 0.5 to 15% by weight of the gum base. The concentration of fillers is from about 10 to about 15% by weight of the gum base. The concentration of antioxidant is from about between 0.01 and 0.1% by weight of the gum base. The concentration of sweetener(s) is from about 5% to about 95% by weight of the gum base, preferably from about 20% to about 80% by weight of the gum base, more preferably from about 30% to about 60% by weight of the gum base. The concentration of artificial sweetener is from about 0.02 to about 8%. The concentration of flavoring agent is from about 0.1% to about 10% by weight of the gum base.

One or more active agents can also be incorporated into the chewing gum base. Suitable classes of active agents include, but are not limited to, antibiotics; anesthetics, such as local anesthetics; analgesics, anitfungal agents, antimicrobial agents, antivirals, antihistamines, anti-inflammatories, cancer therapies, antimycotics, oral contraceptives, diuretics, antitussives, nutraceuticals, probiotics, bioengineered pharmaceuticals, oral vaccines, decongestants, antacids, muscle relaxants, psychotherapeutic agents, hormones, insulin, and cardiovascular agents.

The chewing gum base and optionally one or more additives can be used to manufacture chewing gum. Chewing gum is typically prepared by melting the gum base, incorporating the additives into the molten gum base with mixing, and forming the mixture into chewing gum using techniques known in the art, such as rolling and slicing, extruding or pelleting. Chewing gums formed from the gum bases described herein degrade over a period of time from about four to about six weeks under composting conditions and from about six weeks to about three months under photooxidative conditions. In one embodiment, the degradation time of the chewing gum is such that the gum does not degrade in the consumer's mouth.

### DETAILED DESCRIPTION OF THE INVENTION

### I. Definitions

“Saturated or unsaturated lipid”, as used herein, refers to saturated or unsaturated long chain fatty acids and/or mono, di-, or triglycerides containing at least one additional reactive functional group including, but not limited to, hydroxy groups, amino groups, thiol groups, epoxide groups, carboxylic acid groups, acid derivatives, such as acid chlorides and esters, and double and triple bonds. For example, in one embodiment, the lipid may be a saturated or unsaturated hydroxy fatty acid; amino fatty acid; thiol amino acid; functionalized mono-, di-, or triglyceride, and combinations thereof.

“Functionalized mono-, di-, or triglyceride”, as used herein refers to a mono-, di-, or triglyceride containing at least two reactive functional groups. In one embodiment, the at least two reactive functional groups are sites of unsaturation, such as an alkene, alkyne, or combinations thereof. In another embodiment, the at least two reactive functional groups are one or more reactive functional groups, other than sites of unsaturation, and one or more sites of unsaturation. For mono- and diglycerides, the reactive functional groups include the free hydroxyl groups on the glycerol backbone.

“Saturated or unsaturated polyol” as used herein refers to a compound containing one or more carboxylic acid groups, one or more hydroxyl groups, and combinations thereof. Saturated or unsaturated polyols also include cyclic anhydrides, such as maleic anhydride.

“Crosslink” as used herein refers to the formation of covalent or ionic bonds between the molecular chains of polymer molecules, leading to the formation of a three-dimensional network of polymer chains. Crosslinking usually reduces the thermoplasticity of a material. In one embodiment, the crosslinking results in the formation of covalent bonds, such as carbon-carbon bonds, between polymer chains.

“Natural saturated or unsaturated polycarboxylic acid”, as used herein, refers to a saturated or unsaturated polycarboxylic acid isolated or extracted from natural sources. Unsaturated and saturated refers to the presence or absence of pi bonds (other than the carbon oxygen double bond), typically carbon-carbon double and/or triple bonds.

“Synthetic saturated or unsaturated diacid”, as used herein, refers to saturated or unsaturated polycarboxylic acids that are prepared by chemical synthesis.

“Crosslink density”, as used herein, refers to the average molecular weight or mass between crosslink points.

“Biocompatibility” or “biocompatible”, as generally used herein, refers to the ability of a material to perform with an appropriate host response in a specific application. In the broadest sense, this means a lack of adverse effects to the body in a way that would outweigh the benefit of the material.

“Biodegradable”, as used herein, means the polymers are capable of being broken down into non-harmful products by the action of living things. The polymers can be degraded hydrolytically, enzymatically, or combinations thereof.

“Tackiness”, as used herein, refers to the property of being cohesive and sticky.

“Glass transition temperature”, as used herein, means the temperature at which a polymer changes from hard and brittle to soft and pliable.

“Composting conditions”, as used herein, refers to conditions typically found in municipal and industrial composting facilities.

“Photooxidative conditions”, as used herein, refers to natural weathering conditions as well as artificial weathering conditions used to approximate or mimic natural weathering conditions.

### II. Chewing Gum Compositions

Biodegradable chewing gums containing a gum base containing one or more crosslinked polyesters prepared from saturated or unsaturated lipids, a second monomer derived from a saturated or unsaturated polyol or an oligo- or polyether or polyester, and optionally a third monomer, such as a saturated or unsaturated monocarboxylic acid, polycarboxylic and/or hydroxy acid having 5 carbons or less. The materials are rubbery at room temperature, have a low degree of tackiness, and a low glass transition temperature (T_{g}). The polymers can be used in the preparation of chewing gum bases with out the need for excess plasticizer. The chewing gum compositions degrade over a period of time from about four to about six weeks under composting conditions and from about six weeks to about three months under photooxidative conditions.

A. Chewing Gum Base

The chewing gum is prepared from a chewing gum base containing one or more crosslinked polyesters. The crosslinked polyesters are prepared by crosslinking one or more polyesters containing sites of unsaturation (e.g., carbon-carbon double or triple bonds). In one embodiment, the polyesters are crosslinked via thermally-initiated or photo-initiated free radical polymerization in the presence of a free radical initiator approved for use in food products. In one embodiment, the polyesters are prepared from a saturated or unsaturated lipid, such as a saturated or unsaturated hydroxy or amino fatty acid or a functionalized mono-, di-, or triglyceride; a second monomer derived from a saturated or unsaturated polyol or an oligo- or polyether or polyester, and optionally a third monomer, such as a saturated or unsaturated monocarboxylic acid, polycarboxylic and/or hydroxy acid having 5 carbons or less.

It is not required that both (or all three) monomer units contain one or more sites of unsaturation provided that one or monomers contains one or more sites of unsaturation and are present in a sufficient concentration to form crosslinks between polymer chains. Additional sites of unsaturation can be introduced during the free radical polymerization process. For examples, unsaturated dicarboxylic acids, including but not limited to, fumeric acid, maleic acid, or combinations thereof can be used introduced during free radical polymerization. The addition of one or more unsaturated acid can increase crosslink density and control the consistency of the resulting polymer base.

The polymers described herein have a molecular weight from about 1,000 to about 200,000 Daltons, preferable from about 2000 to about 90,000 Daltons.

1. Saturated and Unsaturated Lipids

Suitable saturated or unsaturated lipids include, but are not limited to, saturated or unsaturated fatty acids that include one or more functional groups in addition to the carboxylic acid groups and/or functionalize mono-, di-, or triglycerides. The functional group can be nucleophilic, such as hydroxy groups (hydroxy fatty acids), amino groups (amino fatty acids), thiol groups (thiol fatty acids). Alternatively, the functional group can be electrophilic, such as epoxide groups or halogen groups. The fatty acid, or the fatty acid moieties in the case of mono-, di-, or triglycerides generally have from 6-30 carbons, preferably from 8-30 carbons, more preferably from 10-30 carbons, most preferably from 10-20 carbons. However, the number of carbons can be less than 6 or greater than 30.

Examples of hydroxy fatty acids include, but are not limited to, castor oil, soybean oil, vernonia oil, and their corresponding fully or partially hydrolyzed or reduced products; hydroxy stearic acid; ricinoleic acid; vernonic acid; coronaric acid; 6-hydroxy-9Z,12Z,14E-octadecatrienoic acid; 9-hydroxy-10E,12Z,15Z-octadecatrienoic acid; 9-hydroxy-10E-octadecenoic acid; 10-hydroxy-8E-octadecenoic acid; 10-hydroxy-12c-octadecenoic acid; 10-hydroxy-12c,15c-octadecadienoic acid, and combinations thereof.

In one embodiment the lipid is an unsaturated lipid containing one or more carbon-carbon double or triple bonds, for example, two, three, four, or more double or triple bonds, and optionally one or more additional reactive functional groups, such as hydroxyl groups, amino groups, thiol groups, epoxide groups, halogen groups, and combinations thereof. In a preferred embodiment, the unsaturated lipid contains one or two carbon-carbon double bonds. The degree of unsaturation in the lipid monomer determines, in part, the crosslink density of the final polymer. Crosslink density can affect the mechanical and physical properties of the polymer, such as tackiness, glass transition temperature, and degradation time.

In one embodiment, the only monomer is an unsaturated mono-, di-, or triglyceride, containing at least two sites of unsaturation. The monomer is crosslinked via the sites of unsaturation to form a higher molecular weight polymer.

2. Saturated or Unsaturated Polyols

The saturated or unsaturated lipid is reacted with a saturated or unsaturated polyol. Suitable polyols include compounds containing one or more carboxylic acid groups (e.g., di, tri, or polycarboxylic acid groups), compounds containing one or more hydroxyl groups (such as di, tri, and polyhydroxy compounds), and combinations thereof. Alternatively, the compound can contain both carboxylic acid groups and hydroxyl groups. Suitable polyols also include anhydrides, preferably cyclic anhydrides, such as maleic anhydrides. The saturated and unsaturated polyols can optionally contain one or more additional reactive functional groups, such as hydroxy groups, amino groups, thiol groups, epoxide groups, halogen groups, and combinations thereof.

Suitable saturated or unsaturated polycarboxylic acids include, but are not limited to, linear alkane dicarboxylic acids, such as malonic acid, succinic acid, glutaric acid, adipic acid, pimelic acid, suberic acid, azelaic acid, uberic acid, sebacic acid and decanedioic acid; linear alkene dicarboxylic acids, such as cis- or trans-2-hexenedioic acid, cis- or trans-3-hexenedioic acid, cis- or tran-3-octenedioic acid, cis- or trans-4-octenedioic acid, cis- or trans-3-octenedioic acid, maleic acid, itaconic acid and combinations thereof. Suitable tricarboxylic acids include, but are not limited to, citric acid, isocitric acid, aconitic acid, and propane-1,2,3-tricarboxylic acid and combinations thereof. In one embodiment, the polycarboxylic acid is an unsaturated aliphatic or aromatic di- or polycarboxylic acid. The polycarboxylic acid can be a mixture of di, tri, and/or polycarboxylic acids. In a preferred embodiment, the polycarboxylic acid is an unsaturated aliphatic or aromatic dicarboxylic acid. Suitable polyhydroxy compounds include saturated diols and triols.

Suitable saturated and unsaturated polyhydroxy compounds include, but are not limited to, 1,2-ethane diol, 1,2-propanediol, 1,3-propanediol, 1,4-butanediol, 1,2-butanediol, 1,2-cyclopentanediol, 1,2-cyclohexanediol, ethane-1,2-diol, 1-propene-1,3-diol, 1-butene-1,4-diol, 2-butene-1,4-diol, glycerol, trimethylol propane, 1,2,6-hexane triol, tripropylene oxide adduct of glycerol or hexane triol, phloroglucinol, 4,6,4′-trihydroxy diphenyl dimethyl methane, and combinations thereof.

The number of carboxylic acid and/or hydroxyl groups on the monomer affects the degree of branching in the polymer, while the degree of unsaturation in the polyol monomer determines, in part, the crosslink density of the final polymer. Crosslink density can affect the mechanical and physical properties of the polymer, such as tackiness, glass transition temperature, and degradation time.

In another embodiment, the second monomer is an oligo- or polyether or polyester.

The uncrosslinked pre-polymer can be formed by reacting the functional groups on the monomers to form the prepolymer. The reactive functional group can be a site of unsaturation or a reactive functional group other than a site of unsaturation.

The mole ratio of the lipid monomer to the second monomer, if present, is from about 1:9 to about 9:1, preferably from about 3:7 to about 7:3, more preferably from about 4:6 to about 6:4. In one embodiment, the ratio is 1:1.

3. Crosslinks

The polymers described herein are covalently crosslinked. In one embodiment, the covalent crosslinks are formed by free radical reaction between carbon-carbon double or triple bonds in adjacent polymer chains using methods known in the art. For example, the pi bonds in the polymer can be crosslinked in the presence of one or more food grade free radical initiators including, but not limited to, potassium persulfate, ammonium persulfate, Benzyl peroxide, di-t-buty peroxide, dicumyl peroxide, lauroyl peroxide, cumene hydroperoxide, p-methane hydroperoxide, a-pinene hydroperoxide, t-butyl hydroperoxide, acetyl acetone peroxide, methyl ethyl ketone peroxide, Succinic acid peroxide, dicetyl peroxydicarbonate, t-butyl peroxyacetate, t-butyl peroxymaleic acid, t-butyl peroxybenzoate, and the like; and the various alkyl perketals such as 2,2-bis-(t-butylperoxy)butane, ethyl 3,3-bis(t-butylperoxy)butyrate, 1,1-di(t-butylperoxy)cyclohexane, and combinations thereof.

The polymer can also be crosslinked by reaction of one or more functional groups other than a carbon-carbon double or triple bond. For example, crosslinks can be formed via Michael Addition reactions where a nucleophilic group, such as an amino, hydroxy, or thiol groups, reacts with an α,β-unsaturated carbonyl group (e,g., aldehydes, ketone, ester, carboxylic acid). In another embodiment, crosslinks can be formed via nucleophilic substitution reactions, such as reaction of a nucleophile, such as a hydroxy, amino, or thiol group, with an electrophilic group, such as an epoxide or halogen group.

The crosslink density can be increased by crosslinking the polymers in the presence of one or more unsaturated polycarboxylic acids. Suitable unsaturated polycarboxylic acids include unsaturated di- and tricarboxylic acids. Exemplary unsaturated polycarboxylic acids include, but are not limited to, fumeric acid, maleic acid, maleic anhydride, pentenedioic acid, hexenedioic acid, heptenedioic acid, octenedioic acid, nonenedioic acid, decenedioic acid, and diene derivatives thereof, unsaturated tricarboxylic acids, and combinations thereof.

The crosslinked polymers have a molecular weight from about 1000 to about 200,000 Daltons, preferably from about 2000 to about 90,000 Daltons. The crosslink density of the polymers is from about 10% to about 75%.

B. Polymer Properties

1. Degradation

The degradation time of the polymer is from about four to about six weeks under composting conditions and from about six weeks to about three months under photooxidative conditions. “Composting conditions” refers to conditions typically found in municipal and industrial composting facilities. For example, degradation studies under composting conditions can be done as described in the ASTM D6400 or D6868 standards, “Photooxidative conditions” refers to natural weathering conditions as well as artificial weathering conditions used to approximate or mimic natural weathering conditions. For example, degradation studies under photooxidative conditions can be done as described in the ASTM G147-96 and G90-98 standards.

2. Tackiness

Tackiness can be measured using a probe tack tester as follows: an acrylic dental probe, or tooth is brought into contact with the masticated gum under controlled conditions of contact pressure and swell time. The bond between the gum and the acrylic probe or tooth is broken under a controlled rate. The force required to break the bond is taken as a measure of tackiness. The test is typically performed by chewing a stick of gum against the dental probe for 5 minutes. The masticated gum is quickly wrapped around a rigid support and the conditioned dental probe clamped to one plate of a conventional trip balance. A 500 gram weight is then placed on the plate supporting the dental probe so that the dental probe is pressed against the masticated gum with a pressure of 500 grams. After 15 seconds the 500 gram weight is removed and additional weights are added to the opposite plate of the balance at a rate of one gram per second until the dental probe separates from the masticated gum. The additional amount of weight is then recorded as the measure of tackiness. After separation, the dental probe is visibly examined to determine if it is free of gum particles. If the probe is free of gum particles the test gum is recorded as being adhesive. The gum is tested at both 5 minutes and at 45 minutes. The tackiness of the polymers as determined by the “probe tack” testing method using a methacrylate test tooth is less than 20 grams.

3. Glass transition temperature

“Glass transition temperature” refers to the temperature at which a polymer changes from hard and brittle to soft and pliable. Glass transition temperatures are typically determined by Differential Scanning calorimetry (DSC). Glass Transition Temperature (Tg) and the Melting Enthalpy (ΔHₘ) were measured with a TA Instruments Differential Scanner Calorimeter provided with a liquid nitrogen cooling system. The instrument was calibrated with a high purity standard (indium). About 10 mg of polymer were placed in an aluminum capsule and cooled to −100° C. The temperature was held for 30 minutes and then heated at a rate of 10° C./min. A second heating was conducted by first heating to 80° C. and holding this temperature for 30 minutes. The sample was then re-cooled to −100° C. and ramped back up to 180° C. at a rate of 10° C./min (2 scanning), Tg was obtained from the thermogram of the second scanning, in order to have a uniform thermal history of the samples. No melting temperature was seen on the DSC curves for any of the samples. The polymers described herein have low glass transition temperatures, for example, from about −20° C. to about 35° C., preferably from about 0° C. to about 30° C.

C. Base Additives

The chewing gum can contain one or more additives suitable for use in food products. Examples of suitable additives include, but are not limited to, emulsifiers, gum base solvents, fillers, antioxidants, plasticizers, sweeteners, flavoring agents, coloring agents, and combinations thereof.

Softeners/emulsifiers include, but are not limited to, tallow, hydrogenated tallow, hydrogenated and partially hydrogenated vegetable oils, cocoa butter, glycerol monostearate, glycerol triacetate, glycerin, lecithin, mono-, di- and triglycerides, acetylated monoglycerides, fatty acids, such as stearic, palmitic, oleic and linoleic acids and combinations thereof. Plasticizers or softeners, are added to the chewing gum in order to improve the chewability and mouthfeel of the gum. The concentration of plasticizers and/or softeners is from about 0.5 to 15% by weight of the gum base.

Suitable fillers include, but are not limited to, calcium carbonate, magnesium carbonate, talc, ground limestone, clay, alumina silicate, alumina, titanium dioxide, mono-, di-, and tricalcium phosphate, cellulose polymers, such as wood, and combinations thereof and mixtures thereof. The amount of filler is from about 10 to about 15% by weight of the gum base.

Suitable antioxidants are those approved for use in food products. Suitable antioxidants include, but are not limited to butylhydroxy anisole (BHA) and butylhydroxy toluene (BHT). The concentration of the antioxidant is from about between 0.01 and 0.1% by weight of the gum base.

Suitable sweeteners include, but are not limited to, sorbitol, hydrogenated starch hydrolysates, cane sugar syrup and combinations thereof, as well as saccharide-containing components conventionally used in chewing gum, such as sucrose, dextrose, maltose, dextrin, dried invert sugar, fructose, levulose, galactose, alone or in combination. Sugar-free sweeteners include, but are not limited to, sugar alcohols, such as sorbitol, mannitol, xylitol, hydrogenated starch hydrolysates, maltitol; as well as known sweeteners aspartame, sucrose, acesulfame and saccharide, either alone or in combination. The concentration of the sweetener(s) is from about 5% to about 95% by weight of the gum base, preferably from about 20% to about 80% by weight of the gum base, more preferably from about 30% to about 60% by weight of the gum base.

Artificial sweeteners can also be used. Preferred artificial sweeteners include, but are not limited to sucralose, aspartame, salts of acesulfame, alitame, saccharin and its salts, cyclamic acid and its salts, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extrusion may be used to achieve the desired release characteristics. Usage level of the artificial sweetener will vary greatly and will depend on such factors as potency of the sweetener, rate of release, desired sweetness of the product, level and type of flavor used and cost considerations. Thus, the active level of artificial sweetener may vary from about 0.02 to about 8%. When carriers used for encapsulation are included, the usage level of the encapsulated sweetener will be proportionately higher.

The chewing gum can further contain a flavoring agent. The concentration of the flavoring agent is from about 0.1% to about 10% by weight of the gum base. Suitable flavoring agents are generally the known food-approved flavors, such as oils derived from plants and fruits, such as citrus oils, fruits essences, peppermint oil, spearmint oil, other mint oils, clove oil, oil of wintergreen, anise and combinations thereof. Artificial flavoring agents and components may also be used. Natural and artificial flavoring agents may be combined.

Suitable colorants and whiteners include FD&C-type dyes and lakes, fruits and vegetable extracts, titanium dioxide and combinations thereof.

Additional ingredients, such mouth conditioners, can also be added to the chewing gum.

D. Active Agents

The chewing gum base described herein can also be used to deliver on or more active agents, locally, systemically, or both. Suitable classes of active agents include, but are not limited to, antibiotics; anesthetics, including local anesthetics; antibiotics; anesthetics, such as local anesthetics; analgesics, anitfungal agents, antimicrobial agents, antivirals, antihistamines, anti-inflammatories, cancer therapies, antimycotics, oral contraceptives, diuretics, antitussives, nutraceuticals, probiotics, bioengineered pharmaceuticals, oral vaccines, decongestants, antacids, muscle relaxants, psychotherapeutic agents, hormones, insulin, and cardiovascular agents. The active agent can be administered delivered locally or systemically. Active agents which can be administered sublingually can be incorporated into the chewing gum.

### III. Methods of Making

A. Methods of Making the Polyesters The polyesters described herein can be made using techniques well known in the art. In general, the polyesters are synthesized neat (or in a solvent or cosolvent) using condensation polymerization and transition metal acid catalysts such as butyl tin oxide at concentrations below about 200 ppm. Water from the reaction is collected using a column condenser. The reaction is monitored using acid number and viscosity measurements. A number of monomer combinations can be used to make polyesters suitable chewing gum base precursors. In one embodiment, a hydroxy functionalized lipid from Arkema is reacted neat with maleic anhydride at 150° C. for six hours. 200 ppm of butyl tin oxide is added at the beginning of the reaction.

Crosslinking is conducted in a reactive extruder using standard food grade free radical initiators. In one embodiment, 0.001% of benzyl peroxide is free blended in the prepolymer and then loaded into the extruder. Standard extrusion techniques are employed for this operation. Other suitable food grade free radical initiators include, but are not limited to, potassium persulfate, ammonium persulfate, Benzyl peroxide, di-t-buty peroxide, dicumyl peroxide, lauroyl peroxide, cumene hydroperoxide, p-methane hydroperoxide, a-pinene hydroperoxide, t-butyl hydroperoxide, acetyl acetone peroxide, methyl ethyl ketone peroxide, succinic acid peroxide, dicetyl peroxydicarbonate, t-butyl peroxyacetate, t-butyl peroxymaleic acid, t-butyl peroxybenzoate, and the like; and the various alkyl perketals such as 2,2-bis-(t-butylperoxy)butane, ethyl 3,3-bis(t-butylperoxy)butyrate, 1,1-di(t-butylperoxy)cyclohexane, and combinations thereof. The free radical polymerization can also be initiated using a redox system, provided the redox system is suitable for use in chewing gum bases.

For example, the polymer described herein can be formed by reacting a polyunsaturated fatty acid with a cyclic anhydride, such as maleic anhydride, a diol, and a triol. The reaction is shown below in Scheme 1.

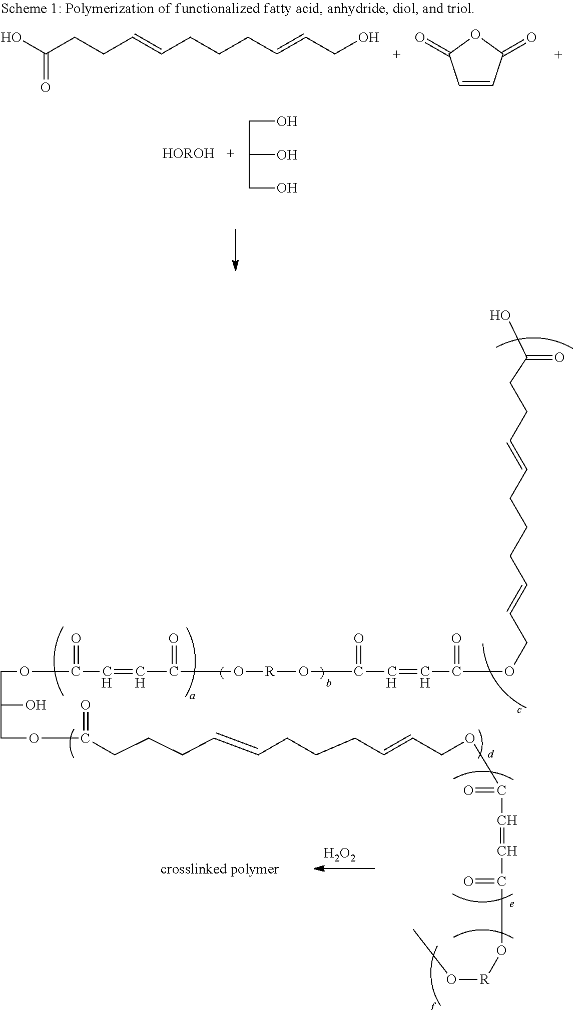

Alternatively, the polymers described therein can be prepared by reaction a functionalized hydroxy fatty acid with a triol to form a triglyceride-type structure and crosslinking the fatty acid chains to form the final polymer. The reaction is shown in Scheme 2.

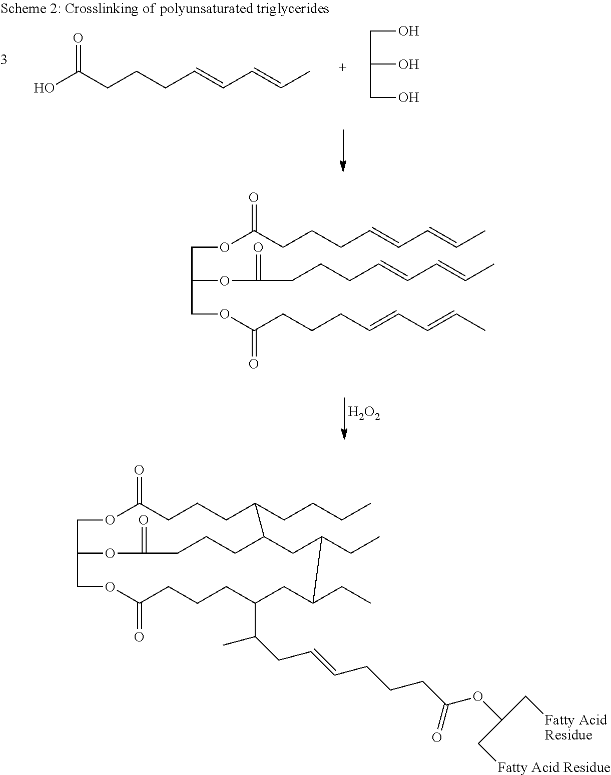

In yet another embodiment, the polymers described herein are prepared by reaction of a cyclic anhydride, such as maleic anhydride, and a functionalized fatty acid, such as a polyepoxy fatty acid in the presence of a free radical initiator. The reaction is shown in Scheme 3.

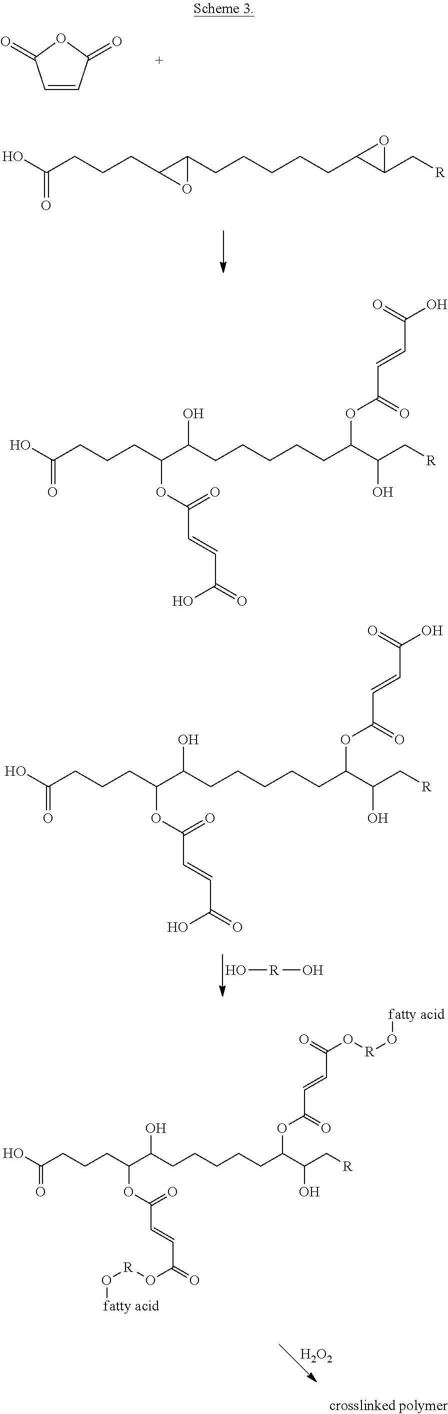

In still another embodiment, the polymers described herein are prepared by reaction of a polyhydroxy fatty acid with a cyclic anhydride, such as maleic anhydride. The reaction is shown in Scheme 4.

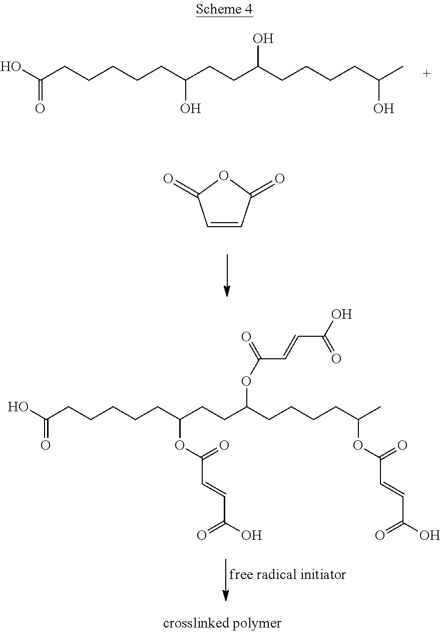

B. Methods of Making Chewing Gum

The chewing gum bases described herein can be used to prepare chewing gum using techniques well known in the art. Generally, the chewing gum is manufactured by successively adding the various chewing gum ingredients to a suitable mixer. After the ingredients have been thoroughly mixed, the mixture is discharged from the mixer and brought into the desired form, for instance by rolling and slicing, extruding or pelleting. In general, the gum base is melted and added to a rotating mixer. Alternatively, the base can be melted in the mixer. Coloring agents, if desired, are preferably added at this time. A plasticizer, if used, is then added to the mixer together with the sweetener(s) and a portion of the filler. Additional components, if desired, can be added. The entire mixing process typically takes from five to fifteen minutes, although longer mixing times are sometimes required. After mixing has been completed, the chewing gum is taken from the mixer and brought into the desired form.

Unless defined otherwise, all technical and scientific terms used herein have the same meanings as commonly understood by one of skill in the art to which the disclosed invention belongs.

1. A biodegradable chewing gum base comprising one or more polymers comprising a first monomer derived from a saturated or unsaturated lipid and optionally a second monomer derived from a saturated or unsaturated polyol, or oligo- or polyether or polyester, wherein the one or more polymers are crosslinked.

2. The base of claim 1, wherein the polymer comprises a first monomer derived from a saturated or unsaturated hydroxy fatty acid or functionalized mono-, di-, or triglyceride and a second monomer derived from a saturated or unsaturated polyol or oligo- or polyether or polyester.

3. The base of claim 2, wherein the saturated or unsaturated hydroxy fatty acid is selected from the group consisting of castor oil, soybean oil, vernonia oil, and their corresponding fully or partially hydrolyzed or reduced products; hydroxy stearic acid; ricinoleic acid; vernonic acid; coronaric acid; 6-hydroxy-9Z,12Z,14E-octadecadienoic acid; 9-hydroxy-10E,12Z,15Z-octadecatrienoic acid; 9-hydroxy-10E-octadecenoic acid; 10-hydroxy-8E-octadecenoic acid; 10-hydroxy-12c-octadecenoic acid; 10-hydroxy-12c,15c-octadecadienoic acid, and combinations thereof.

4. The base of claim 1, wherein the saturated or unsaturated polyol is selected from the group consisting of malonic acid, succinic acid, glutaric acid, adipic acid, pimelic acid, suberic acid, azelaic acid, uberic acid, sebacic acid, decanedioic acid, cis- or trans-2-hexenedioic acid, cis- or trans-3-hexenedioic acid, cis- or tran-3-octenedioic acid, cis- or trans-4-octenedioic acid, cis- or trans-3-octenedioic acid, maleic acid, itaconic acid, citric acid, isocitric acid, aconitic acid, and propane-1,2,3-tricarboxylic acid, maleic anhydride, glycerol, 1,2-ethane diol, 1,2-propanediol, 1,3-propanediol, 1,4-butanediol, 1,2-butanediol, 1,2-cyclopentanediol, 1,2-cyclohexanediol, ethane-1,2-diol, 1-propene-1,3-diol, 1-butene-1,4-diol, 2-butene-1,4-diol, and combinations thereof.

5. The base of claim 1, wherein the polymer comprises a third monomer derived from one or more saturated or unsaturated monocarboxylic acids; polycarboxylics; and/or hydroxy acids having 5 carbons or less.

6. The base of claim 1, wherein the polymers are crosslinked by free radical polymerization.

7. The base of claim 6, wherein, the polymers are crosslinked by thermally initiated or photo-initiated free radical polymerization.

8. The base of claim 1, wherein the polymers are crosslinked in the presence of one or more unsaturated polycarboxylic acid acids.

9. The base of claim 8, wherein the one or more unsaturated polycarboxylic acids are selected from the group consisting of tumeric acid, maleic acid, maleic anhydride, and combinations thereof.

10. The base of claim 1, wherein the polymers are crosslinked via Michael Addition or nucleophilic substitution.

11. The base of one of claim 1, wherein the ratio of the lipid monomer to the polycarboxylic acid monomer is from about 1:9 to about 9:1.

12. The base of one of claim 1, wherein the ratio of the lipid monomer to the polycarboxylic acid monomer is from about 3:7 to about 7:3.

13. The base of one of claim 1, wherein the ratio of the lipid monomer to the polycarboxylic acid monomer is from about 4:6 to about 6:4.

14. The base of claim 1, wherein the molecular weight of the polymer is from about 1000 to about 200,000 Daltons.

15. The base of claim 1, wherein the molecular weight of the polymer is from about 2000 to about 90,000 Daltons.

16. The base of claim 1, wherein the crosslink density of the polymer is from about 10% to about 75%.

17. The base of any of claim 1, wherein the base degrades over a period of time from four to six weeks under composting conditions or six weeks to three months under photooxidative conditions.

18. The base of claim 1, wherein the polymer has a glass transition temperature from about −20° C. to about 35° C.

19. The base of claim 18, wherein the polymer has a glass transition temperature from about 0° C. to about 30° C.

20. The base of claim 1, wherein the tackiness of the base is less than about 20 grams as determined by the probe tack testing method using a methacrylate test tooth.

21. The base of claim 1, further comprising one or more additives selected from the group consisting of emulsifiers, gum base solvents, fillers, antioxidants, plasticizers, sweeteners, flavoring agents, coloring agents, and combinations thereof.

22. A chewing gum comprising the chewing gum base of claim 1.

23. A method for making the biodegradable gum base of claim 1, the method comprising polymerizing a first monomer derived from a saturated or unsaturated lipid and a second monomer derived from a saturated or unsaturated diacid, crosslinking the resulting polymer, and optionally mixing one or more additives with the gum base.

24. The method of claim 23, wherein the polymer is crosslinked by free radical polymerization.

25. The method of claim 24, wherein the polymer is crosslinked in the presence of a free radical initiator.

26. The method of claim 23, wherein the free radical initiator is selected from the group consisting of potassium persulfate, ammonium persulfate, Benzyl peroxide, di-t-buty peroxide, dicumyl peroxide, lauroyl peroxide, cumene hydroperoxide, p-methane hydroperoxide, a-pinene hydroperoxide, t-butyl hydroperoxide, acetyl acetone peroxide, methyl ethyl ketone peroxide, Succinic acid peroxide, dicetyl peroxydicarbonate, t-butyl peroxyacetate, t-butyl peroxymaleic acid, t-butyl peroxybenzoate, and the like; and the various alkyl perketals such as 2,2-bis-(t-butylperoxy)butane, ethyl 3,3-bis(t-butylperoxy)butyrate, 1,1-di(t-butylperoxy)cyclohexane, and combinations thereof.

27. The method of claim 23, wherein the polymer is crosslinked by thermally initiated or photo-initiated free radical polymerization.

28. The method of claim 23, wherein the polymers are crosslinked via Michael Addition or nucleophilic substitution.

29. A method of making a biodegradable chewing gum, the method comprising preparing the gum base of claim 1 and forming it into a shape.

30. The method of claim 28, wherein the chewing gum base is formed into a shape using a technique selected from the group consisting of rolling and slicing, extruding or pelleting.
